(19) United States
(12) Patent Application Publication
(10) Pub. No.: US 2005/0288070 A1
(43) Pub. Date: Dec. 29, 2005

(54) Power saving method in wireless LAN system for estimating at terminal station whether or not data destined thereto is buffered in base station

(75) Inventors: Youko Omori, Tokyo (JP); Shinichi Morimoto, Tokyo (JP)

Correspondence Address: DICKSTEIN SHAPIRO MORIN & OSHINSKY LLP, 1177 AVENUE OF THE AMERICAS (6TH AVENUE), 41 ST FL., NEW YORK, NY, 10036-2714, US

(73) Assignee: NEC Corporation

(21) Appl. No.: 11/155,769

(22) Filed: Jun. 20, 2005

(30) Foreign Application Priority Data
Jun. 29, 2004 (JP) 2004-191378

(51) Int. Cl. H04B 1/38

(52) U.S. Cl. 455/574; 455/41.2

(57) ABSTRACT

A power saving method in a wireless LAN system is disclosed for estimating at a terminal station whether or not data destined thereto is buffered in a base station, and temporarily stopping a downlink data receiving operation when it is estimated that no such data is buffered, thereby preventing the consumption of a bandwidth for needless wireless frame sequences. Upon receipt of a beacon management frame Beacon (TIM) from the base station, the terminal station stores TIM information in a memory. The TIM information indicates whether or not downlink data destined to the terminal station is buffered in the base station (indicating that the data is buffered when it is at “1” and that the data is not buffered when it is at “0”). At a PS-Poll transmission timing, the terminal station references the memory and stops the transmission of PS-Poll when the two latest values of TIM are “00.”

### BACKGROUND OF THE INVENTION

1. Field of the Invention

The present invention relates to a power saving method in a wireless LAN system.

2. Description of the Related Art

In a wireless LAN system which operates asynchronously to a beacon management frame and has a power saving function, a terminal station can receive downlink data at an arbitrary timing without being fixed at a beacon period. Therefore, a power saving operation can be accomplished without largely increasing a data delay time even during the power saving operation.

However, in the prior art described above, since the terminal station operates asynchronously to a beacon management frame, the terminal station attempts to receive downlink data at an arbitrary timing irrespective of whether a base station is buffering data destined to the terminal station. As such, when there is not data destined to the terminal station in the base station, the terminal station consumes a bandwidth for unnecessary PS-Poll control frames and continuous wireless frame sequences.

### SUMMARY OF THE INVENTION

It is an object of the present invention to provide a power saving method in a wireless LAN system, which prevents a terminal station from consuming a bandwidth for unnecessary wireless frame sequences.

To achieve the above object, in a power saving method in a wireless LAN system according to the present invention, as a terminal station receives a beacon signal from a base station to which the terminal station is subordinate, the terminal station extracts TIM information from the beacon signal, and stores the TIM information in a memory. The TIM information indicates whether or not the base station contains data destined to this terminal station. Then, at a timing of transmitting a PS-Poll signal to the base station for prompting the same to transmit data destined to the terminal station, asynchronous to the beacon signal reception timing, the terminal station references a log of the TIM information stored in the memory to determine based on the log whether the PS-Poll signal should be transmitted or stopped.

By thus estimating whether or not the base station contains data destined to the terminal station using the log of the TIM information, the power saving method according to the present invention can save the power consumed by the terminal station because the terminal station can reduce the transmission of useless PS-Poll management frames and a wireless frame sequences associated therewith when downlink data to be received by the terminals station is not buffered in the base station. As a result, it is possible to avoid useless consumption of wireless resources to increase the transmission capacity, as viewed in the whole system.

In another power saving method, as a terminal station receives a beacon signal from a base station to which the terminal station is subordinate, the terminal station extracts TIM information from the beacon signal, and stores the TIM information in a memory. The TIM information indicates whether or not the base station contains data destined to the terminal station. The terminal station further stores data reception information, which indicates whether or not the terminal station has received data destined thereto, in the memory as a response to a PS-Poll signal transmitted to the base station at a transmission timing for prompting the same to transmit data destined to the terminal station. The transmission timing is asynchronous to a timing at which the beacon signal is received. Then, the terminal station references a log of the TIM information or data reception information stored in the memory to determine based on the referenced log whether the PS-Poll signal is transmitted or stopped.

In this way, the terminal station estimates whether or not the base station contains data destined to the terminal station, using the log of the data reception information or TIM information, thereby preventing the transmission of useless PS-Poll signals.

The above and other objects, features and advantages of the present invention will become apparent from the following description with reference to the accompanying drawings which illustrate examples of the present invention.

### BRIEF DESCRIPTION OF THE DRAWINGS

FIG. 1 is a diagram illustrating an exemplary frame sequence for a power saving method in a wireless LAN system according to one embodiment of the present invention;

FIG. 2 is a diagram illustrating another exemplary frame sequence for a power saving method in a wireless LAN system according to one embodiment of the present invention; and

FIG. 3 is a block diagram illustrating an exemplary configuration of a terminal station in one embodiment of the present invention.

### DETAILED DESCRIPTION OF THE PREFERRED EMBODIMENTS

A terminal station of the present invention can know whether or not downlink data destined thereto has been buffered in a base station by analyzing TIM (Traffic Indication Map) included in a beacon management frame transmitted from the base station. The terminal station can also know whether or not downlink data destined thereto has been buffered in the base station by determining the presence or absence of downlink data for a PS-Poll management frame transmitted by the terminal station to the base station.

The terminal station stores a log as to whether or not downlink data destined thereto is buffered in the base station.

For transmitting a PS-Poll management frame at an arbitrary timing asynchronous to the beacon management timing, the terminal station references the log stored in a memory as to whether or not past downlink data destined thereto is buffered in the base station.

Specifically, when there has not been downlink data destined to the terminal station beyond a certain time, the terminal station temporarily stops the transmission of the PS-Poll management frame, as well as a sequence of subsequent downlink data receiving operations. On the other hand, when the terminal station has been informed by a preceding beacon management frame that downlink data destined to the terminal station has been buffered in the base station, as indicated by the log, the terminal station transmits a PS-Poll management frame, and performs a sequence of subsequent link data receiving operations without fail.

By thus applying a power saving function, which operates asynchronously to the beacon management frame, while referencing the log stored in the memory as to whether or not downlink data destined to the terminal station has been buffered in the base station in the past, it is possible to reduce the transmission of useless PS-Poll management frames and wireless frame sequences associated therewith when downlink data to be received by the terminal station is not buffered in the base station.

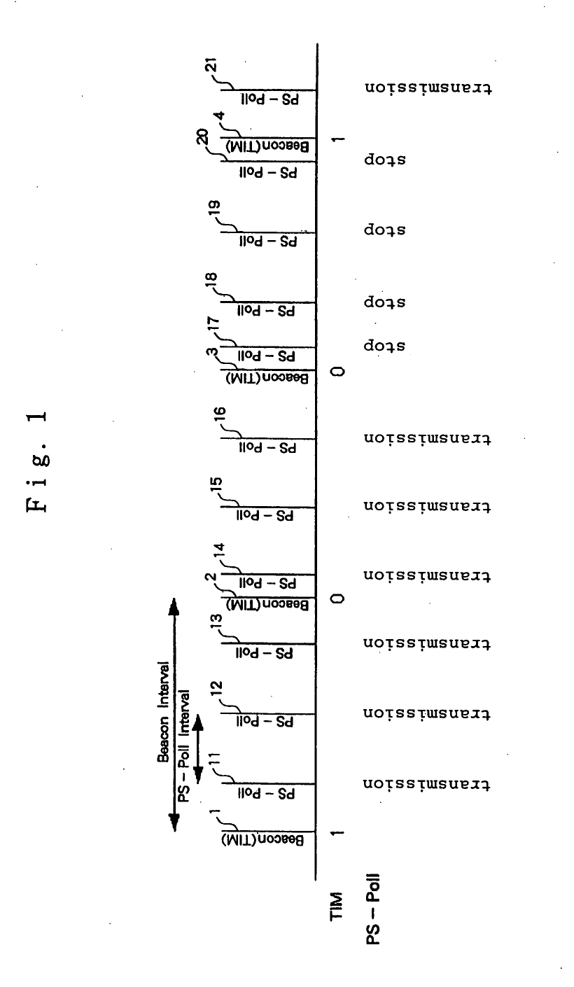

Referring to FIG. 1, an exemplary frame sequence is illustrated for a power saving method in a wireless LAN system in accordance with one embodiment of the present invention. The illustrated example shows that a terminal station stops the transmission of PS-Poll when the value of TIM is “0” N times in succession (“0” indicates that downlink data destined to the terminal station is not buffered in a base station), and resumes the transmission of PS-Poll when the terminal station detects that the value of TIM is “1” (“1” indicates that downlink data destined to the terminal station has been buffered in the base station). N is set to two, by way of example.

In FIG. 1, Beacon (TIM) is a signaling information of the base station. Beacon (TIM) 1 has the value “1” which indicates that downlink data destined to the terminal station has been buffered in the base station. The terminal station stores the value of TIM in a memory. At PS-Poll transmission timing 11, the terminal station references a TIM log from the memory, and transmits PS-Poll because the two latest TIM's are not “0” in succession. Subsequently, at PS-Poll transmission timings 12, 13, the terminal station references the TIM log from the memory, and transmits PS-Poll because the two latest TIM's are not “0” in succession.

Next, the terminal station receives Beacon (TIM) 2. Beacon (TIM) 2 has the value “0” indicating that downlink data for the terminal station is not buffered in the base station. The terminal station stores the value of TIM in the buffer. At PS-Poll transmission timing 14, the terminal station references the TIM log from the memory, and transmits PS-Poll because the two latest TIM are not “0” in succession. Subsequently, at PS-Poll transmission timings 15, 16, the terminal station also references the TIM log from the memory, and transmits PS-Poll because the two latest TIM are not “0” in succession.

Next, the terminal station receives Beacon (TIM) 3. Beacon (TIM) 3 has the value “0” which indicates that downlink data for the terminal station is not buffered in the base station. The terminal station stores the value of TIM in the memory. At PS-Poll transmission timing 17, the terminal station references the TIM log from the memory, and stops the transmission of PS-Poll because the two latest TIM's are “0” in succession. Subsequently, at PS-Poll transmission timings 18, 20, the terminal station also references the TIM log from the memory, and stops the transmission of PS-Poll because the two latest TIM are “0” in succession.

Next, the terminal station receives Beacon (TIM) 4. Beacon (TIM) 4 has the value “1” which indicates that downlink data for the terminal station has been buffered in the base station. The terminal station stores the value of TIM in the memory. At PS-Poll transmission timing 21, the terminal station references the TIM log from the memory, and transmits PS-Poll because the two latest TIM's are not “0” in succession.

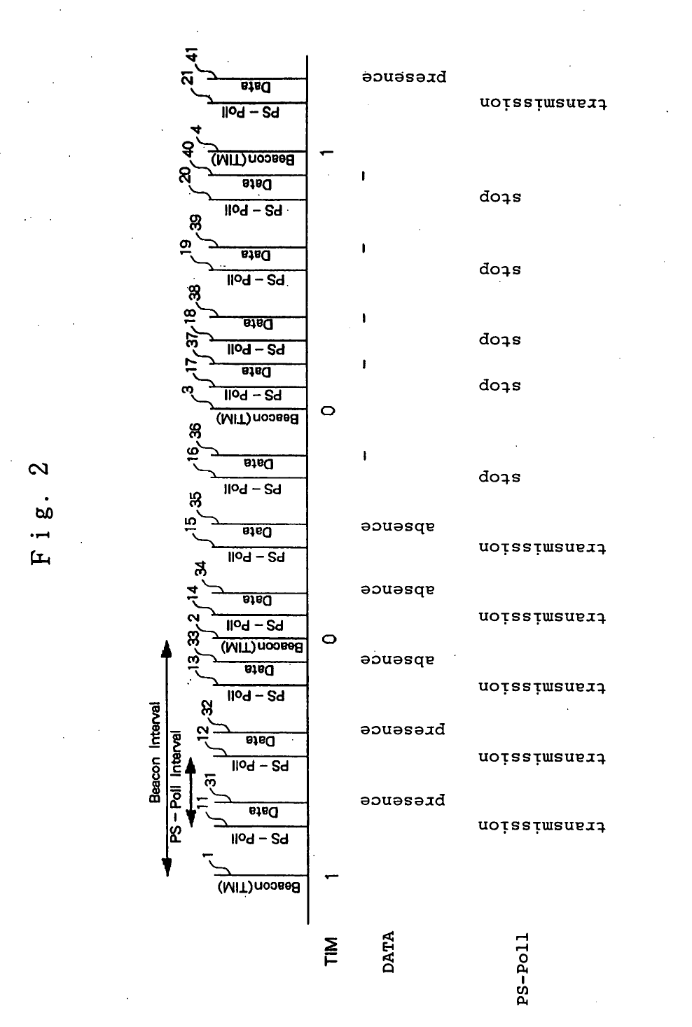

Referring to FIG. 2, there is illustrated another exemplary frame sequence for a power saving method in a wireless LAN system according to one embodiment of the present invention. This example shows a scenario in which a terminal station stops transmitting PS-Poll when no data is transmitted from a base station for M successive PS-Polls from the terminal station, and resumes the transmission of PS-Poll when the terminal station detects that the value of Beacon (TIM) is “1.” M is set to three, by way of example.

Beacon (TIM) is signaling information of the base station. Beacon (TIM) 1 has the value “1” which indicates that downlink data for the terminal station has been buffered in the base station. The terminal station stores the value of TIM in a memory. At PS-Poll transmission timing 11, the terminal station references a TIM log from the memory, and transmits PS-Poll because the latest TIM is “1” in the log. The base station transmits downlink data to the terminal station in response to PS-Poll 11 when it is buffering the data. The terminal station stores in the memory the presence or absence of data transmitted from the base station in response to PS-Poll 11 (PRESENCE).

At PS-Poll transmission timing 12, the terminal station references a base station data transmission log from the memory, and transmits PS-Poll because the three latest transmissions are not “ABSENCE” in succession in the log. The terminal station stores in the memory the presence or absence of data transmitted from the base station in response to PS-Poll 12 (PRESENCE).

At PS-Poll transmission timing 13, the terminal station references the base station data transmission log from the memory, and transmits PS-Poll because the three latest transmissions have been performed (PRESENCE) in succession in the log. The terminal station stores in the memory the presence or absence of data transmitted from the base station in response to PS-Poll 13 (ABSENCE).

At PS-Poll transmission timings 14, 15, the terminal station also references the base station data transmission log from the memory, and transmits PS-Poll because the three latest transmissions have been performed (PRESENCE). The terminal station stores in the memory the presence or absence of data transmitted from the base station in response to PS-Poll (ABSENCE).

At PS-Poll transmission timing 16, the terminal station references the base station data transmission log from the memory, and again references a TIM log from the memory to confirm the latest TIM log because the three latest transmissions have not been performed (ABSENCE) in succession. Since the latest TIM has the value “0” of Beacon (TIM) 2, the terminal station stops the transmission of PS-Poll. Since the terminal station does not transmit PS-Poll, no data will be transmitted from the base station. In this event, therefore, the terminal station does not store in the memory the presence or absence of data transmitted from the base station.

At PS-Poll transmission timing 17, the terminal station references the base station data transmission log from the memory, and again references the TIM log from the memory to confirm the latest TIM log because the three latest transmissions have not been performed (ABSENCE) in succession. Since the latest TIM has the value “0” of Beacon (TIM) 3, the terminal station stops the transmission of PS-Poll. Since the terminal station does not transmit PS-Poll, no data will be transmitted from the base station. In this event, therefore, the terminal station does not store in the memory the presence or absence of data transmitted from the base station. The terminal station performs similar operations as well at PS-Poll transmission timings 18 to 20.

At PS-Poll transmission timing 21, the terminal station references the base station data transmission log from the memory, and again references the TIM log from the memory to confirm the latest TIM log because the three latest transmissions have not been performed (ABSENCE) in succession. Since the latest TIM has the value “1” of Beacon (TIM) 4, the terminal station transmits PS-Poll. The terminal station stores in the memory the presence or absence of data transmitted from the base station in response to PS-Poll 21 YES).

In the example illustrated in FIG. 2, the terminal station transmits PS-Poll or stops the transmission of PS-Poll depending on the number of times data has not been transmitted from the base station in response to PS-Poll. Alternatively, instead of the number of times, the terminal station may transmit PS-Poll or stop the transmission of PS-Poll depending on whether or not data has been transmitted within a preceding particular time period. Specifically, the terminal station may stop the transmission of PS-Poll when no data has been communicated from the base station for preceding P msec.

In another example, when the terminal station determines to stop the transmission of PS-Poll, the terminal station may stop the transmission of PS-Poll the subsequent X times and resume the transmission of PS-Poll at an (X+1)th PS-Poll transmission timing. In this event, the terminal station may not reference the Beacon (TIM) log. The number of times X may vary depending on the time or on the number of times the terminal station has stopped the transmission of PS-Poll.

The foregoing frame sequence may be executed by reading a computer program or a computer-readable recording medium which has recorded thereon such a computer program.

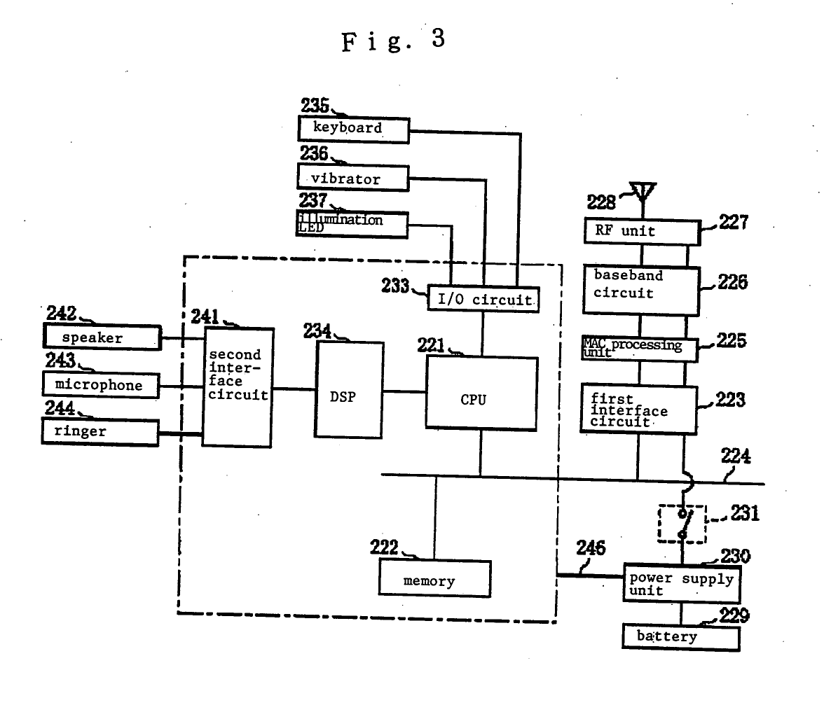

Referring to FIG. 3, there is illustrated an exemplary configuration of the terminal station in the foregoing embodiment.

The terminal station comprises CPU (central processing unit) 221 having central functions for a variety of controls; memory 222 for temporarily storing a control program, TIM log (“0” and “1”), base station data reception log (“PRESENCE” and “ABSENCE”); first interface circuit 223; and bus 224 which interconnects these components. Connected to first interface circuit 223 is one end of a series circuit composed of MAC processing unit 225 for processing a MAC (Media Access Control) address of the wireless LAN; baseband circuit 226 for processing a baseband signal; and RF (Radio Frequency) unit 227. RF unit 227 is connected to antenna 228 for transmitting/receiving radio waves (including the reception of the beacon management frame, and the transmission of the PS-Poll management frame). First interface circuit 223, MAC processing unit 225, baseband circuit 226, and RF unit 227 are each powered by a power supply unit 230, to which battery 229 is connected, such that the power supply can be controlled on/off by switch circuit 231.

CPU 221 is also connected to input/output (I/O) circuit 223 and DSP (Digital Signal Processor) 234 in addition to bus 224. Input/output circuit 233 is connected to a variety of devices such as keyboard 235 for entering characters and the like; vibrator 236 for informing through vibrations; illumination LED (Light Emitting Diode) 237 for illuminating a display, not shown, during a communication and the like, and so on. DSP 234 in turn is connected to speaker 242, microphone 243, and ringer 244 through second interface circuit 241. Here, ringer 244 is a circuit for generating sound when a communication partner is called. CPU 221, memory 222, input/output circuit 233, DSP 234, and second interface circuit 241 are directly coupled to power supply unit 230 through power supply line 246, such that the respective components are powered at all times unless the power output of power supply nit 230 is turned off by a main switch, not shown.

While preferred embodiments of the present invention have been described using specific terms, such description is for illustrative purposes only, and it is to be understood that changes and variations may be made without departing from the spirit or scope of the following claims.

1. A power saving method in a wireless LAN system, comprising:
a first step at which, upon receipt of a beacon signal from a base station to which a terminal station is subordinate, said terminal station extracts TIM information from the beacon signal, said TIM information indicating whether or not said base station contains data destined to said terminal station, and stores the extracted TIM information in a memory; and
a second step at which said terminal station references a log of the TIM information stored in said memory to determine based on the log of the TIM information whether or not said terminal station transmits a PS-Poll signal for prompting said base station to transmit data destined to said terminal station at a timing at which said terminal station transmits the PS-Poll signal to said base station, said transmission timing being asynchronous to the timing at which said terminal station receives the beacon signal.

2. The power saving method according to claim 1, wherein:
at said second step, said terminal station stops the transmission of the PS-Poll signal when a predetermined number of pieces of the latest TIM information indicate that said base station does not contain the data destined to said terminal station.

3. The power saving method according to claim 2, wherein:
at said second step, said terminal station resumes the transmission of the PS-Poll signal when a predetermined number of pieces of the latest TIM information indicate that said base station does not contain the data destined to said terminal station.

4. The power saving method according to claim 2, wherein said terminal station resumes the transmission of the PS-Poll signal at a transmission timing several number of timings after said terminal station stops the transmission of the PS-Poll signal.

5. A power saving method in a wireless LAN system, comprising:
a third step at which, upon receipt of a beacon signal from a base station to which a terminal station is subordinate, said terminal station extracts TIM information from the beacon signal, said TIM information indicating whether or not said base station contains data destined to said terminal station, and stores the extracted TIM information in a memory;
a fourth step at which said terminal station stores data reception information indicating whether or not said terminal station has received the data destined thereto in said memory as a response to a PS-Poll signal transmitted to said base station at a transmission timing for prompting said base station to transmit the data. destined to said terminal station, said transmission timing being asynchronous to a timing at which said terminal station receives the beacon signal; and
a fifth step at which said terminal station references a log of the TIM information or the data reception information stored in said memory at the transmission timing to determine based on the log whether said terminal station transmits the PS-Poll signal or stops the transmission of the PS-Poll signal.

6. The power saving method according to claim 5, wherein:
at said fifth step, said terminal station stops the transmission of the PS-Poll signal when a predetermined number of pieces of the latest data reception information indicate that said terminal station has not received the data destined to said terminal station, and when the latest TIM information indicates that said base station does not contain the data destined to said terminal station.

7. The power saving method according to claim 6, wherein:
at said fifth step, said terminal station resumes the transmission of the PS-Poll signal when a predetermined number of pieces of the latest data reception information do not indicate that said terminal station has not received the data destined to said terminal station, and when the latest TIM information indicates that said base station does not contain the data destined to said terminal station.

8. The power saving method according to claim 6, wherein said terminal station resumes the transmission of the PS-Poll signal at the transmission timing several number of timings after said terminal station stops the transmission of the PS-Poll signal.

9. The power saving method according to claim 5, wherein:
at said fifth step, said terminal station stops the transmission of the PS-Poll signal when the data reception information within a predetermined time period traced back from a current time indicates that said terminal station has not received the data destined thereto, and when the latest TIM information indicates that said base station does not contain the data destined to said terminal station.

10. The power saving method according to claim 9, wherein:
at said fifth step, said terminal station resumes the transmission of the PS-Poll signal when the data reception information within a predetermined time period traced back from a current time does not indicate that said terminal station has not received the data destined thereto, or when the latest TIM information indicates that said base station contains the data destined to said terminal station.

11. The power saving method according to claim 9, wherein said base station resumes the transmission of the PS-Poll signal at the transmission timing several number of times after said terminal station stops the transmission of the PS-Poll signal.

12. A terminal station having a power saving function which operates asynchronously to a timing at which said terminal station receives a beacon signal from a base station to which said terminal station is subordinate in a wireless LAN system, said terminal station comprising:
a memory;
means responsive to the beacon signal received from said base station for extracting TIM information from the beacon signal, said TIM information indicating whether or not said base station contains data destined to said terminal station, and storing the TIM information in said memory; and
means for referencing a log of the TIM information stored in said memory to determine based on the log whether a PS-Poll signal for prompting said base station to transmit data destined to said terminal station is transmitted or stopped at a timing at which said terminal station transmits the PS-Poll signal to said base station, said transmission timing being asynchronous to a timing at which said terminal station receives the beacon signal.

13. A terminal station having a power saving function which operates asynchronously to a timing at which said terminal station receives a beacon signal from a base station to which said terminal station is subordinate in a wireless LAN system, said terminal station comprising:
a memory;
means for storing data reception information indicating whether or not said terminal station has received data destined thereto in said memory as a response to a PS-Poll signal transmitted to said base station for prompting said base station to transmit data destined to said terminal station at a transmission timing asynchronous to a timing at which said terminal station receives the beacon signal; and
means for referencing a log of the data reception information stored in said memory to determine based on the log whether the PS-Poll signal is transmitted or stopped at the transmission timing.

14. A terminal station having a power saving function which operates asynchronously to a timing at which said terminal station receives a beacon signal from a base station to which said terminal station is subordinate in a wireless LAN system, said terminal station comprising:
a memory;
means responsive to the beacon signal received from said base station for extracting TIM information from the beacon signal, said TIM information indicating whether or not said base station contains data destined to said terminal station, and storing the TIM information in said memory;
means for storing data reception information indicating whether or not said terminal station has received data destined thereto in said memory as a response to a PS-Poll signal transmitted to said base station for prompting said base station to transmit data destined to said terminal station at a transmission timing asynchronous to a timing at which said terminal station receives the beacon signal; and
means for referencing a log of the TIM information or the data reception information stored in said memory to determine based on the referenced log whether the PS-Poll signal is transmitted or stopped at the transmission timing.

15. A wireless LAN system comprising:
a base station; and
the terminal station according to claim 12, said terminal station being subordinate to said base station.

16. A wireless LAN system comprising:
a base station; and
the terminal station according to claim 13, said terminal station being subordinate to said base station.

17. A wireless LAN system comprising:
a base station; and
the terminal station according to claim 14, said terminal station being subordinate to said base station.
